(19) United States
(12) Patent Application Publication
(10) Pub. No.: US 2025/0219713 A1
(43) Pub. Date: Jul. 3, 2025

(54) RADIO COMMUNICATION SYSTEM, RADIO COMMUNICATION METHOD, AND RADIO SIGNAL RECEIVING DEVICE

(71) Applicant: NIPPON TELEGRAPH AND TELEPHONE CORPORATION, Tokyo (JP)

(72) Inventors: Hitoshi HASEGAWA, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/835,090

(22) PCT Filed: Feb. 9, 2022
(86) PCT No.: PCT/JP2022/005118

§ 371 Date: Aug. 1, 2024

(51) Int. Cl. H04B 7/155; H04B 1/04

(52) U.S. Cl. CPC H04B 7/15528; H04B 1/04

(57) ABSTRACT

A transmission station that performs a variable transmission output and a reception station having a function of relaying a wireless signal are provided. The reception station includes an attenuator that attenuates a reception input captured from an antenna at a desired attenuation rate. A C/I that is an intensity ratio between a carrier wave C that is sent from the transmission station and reaches the antenna and an interference wave I that reaches the antenna is detected. In a case where the C/I of a reception input is smaller (for example, 30 dB) than a request value (for example, 35 dB), an increase in transmission output is requested to the transmission station, and attenuation of the reception input is requested to the attenuator to obtain an attenuation input that satisfies standards.

### TECHNICAL FIELD

The present disclosure relates to a radio communication system, a radio communication method, and a radio signal receiving device, and particularly, to a radio communication system, a radio communication method, and a radio signal receiving device suitable for use in an environment with an interference wave.

### BACKGROUND ART

Patent Literature 1 below discloses a technology for preventing communication signals from interfering with each other when devices using adjacent frequencies are arranged close to each other. Specifically, Patent Literature 1 discloses a system using a wireless power transmitter that generates a power signal having a specific frequency for the purpose of supplying power and an adjacent-frequency-using device that is operated by receiving the supplied power and generates a wireless signal having a frequency adjacent to the frequency of the power signal.

In order to operate the adjacent-frequency-using device, it is necessary to transmit the power signal to the device for securing operating power. On the other hand, under conditions where such wireless signal is being transmitted, if the adjacent-frequency-using device emits a wireless signal, the former will interfere with the latter, and making it impossible to obtain the desired communication quality.

Patent Literature 1 discloses a technology in which the adjacent-frequency-using device requests the wireless power transmitter to stop transmission of the power signal when the wireless signal is emitted, in order to avoid interference between the signals. When the transmission of the power signal is stopped, an interference wave disappears, and thus the wireless signal emitted from the adjacent-frequency-using device is properly transmitted. Therefore, according to the technology described in Patent Literature 1, it is possible to solve deterioration of communication quality caused by an interference signal.

### CITATION LIST

### Patent Literature

JP 2012-235674 A

### SUMMARY OF INVENTION

### Technical Problem

However, the technology described in Patent Literature 1 can be used only under conditions in which a device that generates an interference wave complies with a request from a device that receives the interference wave. On the other hand, in an actual environment, various devices independently generate wireless signals, and situations in which it is not possible to request the stop of the interference wave occur frequently. Accordingly, the technology described in Patent Literature 1 cannot provide a solution for avoiding interference under such conditions.

The present disclosure has been made in view of the above problems, and a first object thereof is to provide a wireless communication system capable of ensuring desired communication quality in an environment where a carrier wave and an interference wave have to coexist.

In addition, a second object of the present disclosure is to provide a wireless communication method for ensuring desired communication quality in an environment where a carrier wave and an interference wave have to coexist.

In addition, a third object of the present disclosure is to provide a wireless signal receiving apparatus capable of ensuring desired communication quality in an environment where a carrier wave and an interference wave have to coexist.

### Solution to Problem

According to a first aspect, in order to achieve the object described above, there is provided a wireless communication system including: a transmission station of a wireless signal, which performs a variable transmission output; and a reception station having a function of relaying the wireless signal. The reception station includes an attenuator that attenuates a reception input captured from an antenna at a desired attenuation rate. It is desirable that the reception station be configured to execute a process of detecting a C/I that is an intensity ratio between a carrier wave C that is sent from the transmission station and reaches the antenna and an interference wave I that reaches the antenna, a process of requesting the transmission station to increase the transmission output in a case where the C/I is smaller than a request value to be secured, and a process of requesting the attenuator to attenuate the reception input in a case where the C/I is smaller than the request value.

In addition, according to a second aspect, there is provided a wireless communication method using a transmission station of a wireless signal, which performs a variable transmission output and a reception station having a function of relaying the wireless signal. The reception station includes an attenuator that attenuates a reception input captured from an antenna at a desired attenuation rate. The wireless communication method includes: a step of detecting a C/I that is an intensity ratio between a carrier wave C that is sent from the transmission station and reaches the antenna and an interference wave I that reaches the antenna, a step of requesting the transmission station to increase the transmission output in a case where the C/I is smaller than a request value to be secured, and a step of requesting the attenuator to attenuate the reception input in a case where the C/I is smaller than the request value.

In addition, according to a third aspect, there is provided a wireless signal receiving apparatus having a function of relaying a wireless signal transmitted from a transmission station that performs a variable transmission output, the wireless signal receiving apparatus including: an attenuator that attenuates a reception input captured from an antenna at a desired attenuation rate. It is desirable that the wireless signal receiving apparatus be configured to execute a process of detecting a C/I that is an intensity ratio between a carrier wave C that is sent from the transmission station and reaches the antenna and an interference wave I that reaches the antenna, a process of requesting the transmission station to increase the transmission output in a case where the C/I is smaller than a request value to be secured, and a process of requesting the attenuator to attenuate the reception input in a case where the C/I is smaller than the request value.

### Advantageous Effects of Invention

According to the first to third aspects, it is possible to secure desired communication quality in an environment where a carrier wave and an interference wave have to coexist.

### BRIEF DESCRIPTION OF DRAWINGS

FIG. 1 is a block diagram for describing a configuration of a wireless communication system of Embodiment 1 of the present disclosure.

FIG. 2 is a diagram for describing a characteristic operation of the wireless communication system illustrated in FIG. 1.

FIG. 3 is a flowchart for describing a flow of main processing executed in the wireless communication system illustrated in FIG. 1.

### DESCRIPTION OF EMBODIMENTS

### Embodiment 1

### Configuration of Embodiment 1

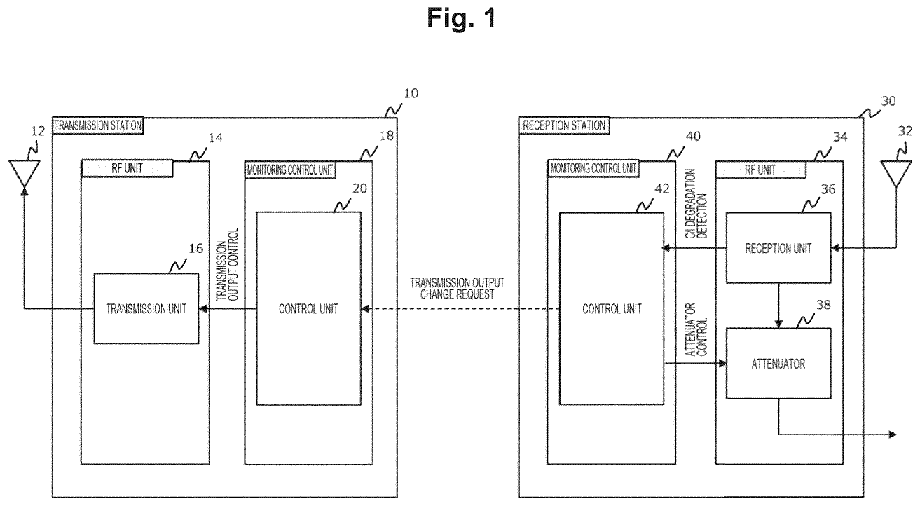

FIG. 1 is a block diagram for describing a configuration of a wireless communication system of Embodiment 1 of the present disclosure. The configuration to be described below can be configured of an electronic circuit with dedicated hardware. In addition, a memory storing a program and a processing unit may be combined with the dedicated hardware to cause the processing unit to execute the program, thereby realizing a part of the processing.

As illustrated in FIG. 1, the wireless communication system of the present embodiment includes a transmission station 10 of a wireless signal. The transmission station 10 includes an antenna 12 for transmitting and receiving the wireless signal. A transmission unit 16 included in a radio frequency (RF) unit 14 is connected to the antenna 12.

The transmission unit 16 is provided with a control signal from the control unit 20 included in a monitoring control unit 18. The control signal includes, for example, a command related to transmission power. The transmission unit 16 converts a signal provided from a signal providing unit (not illustrated) into a high-frequency signal and supplies the high-frequency signal to the antenna 12 with transmission power designated by the control unit 20. The antenna 12 receives the supply and transmits a wireless signal.

The wireless communication system illustrated in FIG. 1 includes a reception station 30. The reception station 30 has a function of receiving and relaying the wireless signal transmitted from the transmission station 10. Therefore, the reception station 30 may be referred to as a wireless signal receiving apparatus or a wireless signal relaying apparatus.

The reception station 30 includes an antenna 32 for transmitting and receiving a wireless signal. The wireless signal transmitted from the transmission station 10 is received by the antenna 32. In addition, the wireless signal transmitted by the reception station 30 to relay the received signal is also transmitted from the antenna 32. However, another antenna for the reception station 30 to transmit a wireless signal may be provided independently of the antenna 32.

The signal received by the antenna 32 is provided to a reception unit 36 included in an RF unit 34 of the reception station 30. The reception unit 36 provides a reception input to an attenuator 38 and calculates a C/I of the reception input, that is, an intensity ratio between a carrier wave and an interference wave, in order to realize a relay function.

The C/I calculated by the reception unit 36 is provided to a control unit 42 included in a monitoring control unit 40. The control unit 42 has a function of determining whether or not the C/I has decreased to a value lower than a preset threshold. Accordingly, the control unit 42 generates a command to the attenuator 38 and a request to the control unit 20 of the transmission station 10 as necessary on the basis of the determination result.

The attenuator 38 attenuates the reception input provided from the reception unit 36 in response to the command from the control unit 20. The signal processed by the attenuator 38 is provided to a transmission unit (not illustrated) via a reception port (not illustrated) and is transmitted as a wireless signal from the antenna 32 or a separately provided transmission dedicated antenna.

The control unit 42 of the reception station 30 can issue a request for changing the transmission output to the control unit of the transmission station 10. In FIG. 1, for convenience, a dashed arrow representing a transmission output change request is drawn between the control unit 42 and the control unit 20, but this request is transmitted from the reception station 30 to the transmission station 10 in a form of a wireless signal. When the request for changing the transmission output is received, the control unit 20 of the transmission station 10 changes the command of the transmission power to the transmission unit 16 depending on the request.

As described above, the wireless communication system of the present embodiment can realize the following four functions.
(1) The reception station 30 can detect a decrease in C/I of the wireless signal transmitted from the transmission station.
(2) The reception station 30 can appropriately attenuate the reception input and send the attenuated signal to the reception port.
(3) The reception station 30 can request the transmission station 10 to change the transmission output.
(4) The transmission station 10 can change the transmission power of the transmission signal in response to the request of the reception station.

### Characteristic Operation of Embodiment 1

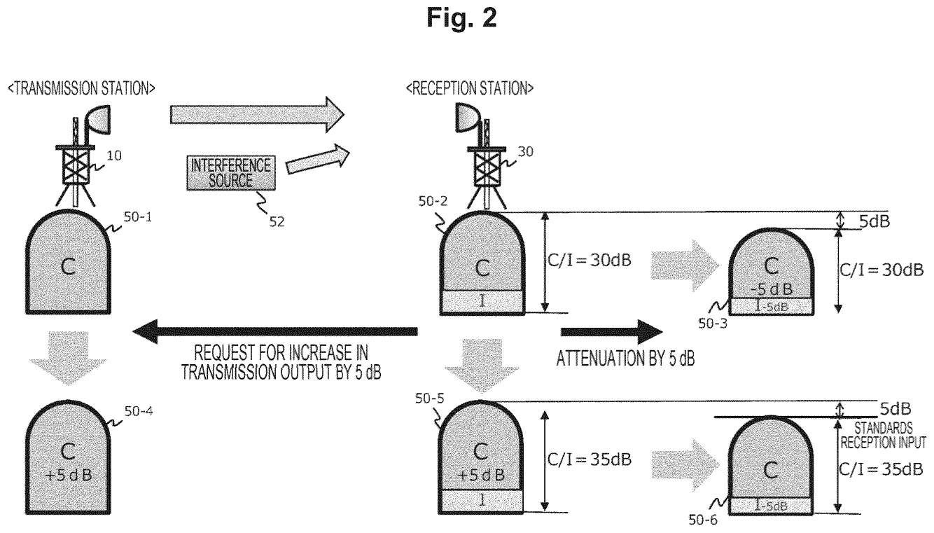

FIG. 2 is a diagram for describing a characteristic operation of the wireless communication system of the present embodiment. On the upper left side of FIG. 2, a state in which the transmission station 10 transmits a signal configured of the carrier wave (C) by a transmission output 50-1 is illustrated. In addition, at the upper part of FIG. 2, an example in which an interference source 52 exists between the transmission station 10 and the reception station 30, and the carrier wave (C) emitted from the transmission station 10 reaches the reception station 30 together with the interference wave (I) emitted from the interference source 52 is illustrated.

Accordingly, at the center of the upper part of FIG. 2, a state in which an input 50-2 in which the carrier wave (C) and the interference wave (I) described above are mixed is received by reception station 30 is illustrated. Here, it is assumed that the C/I of the reception input 50-2 is “30 dB”.

In a case where the transmission station 10 and the reception station 30 share a frequency with the interference source 52, a wireless signal emitted by the interference source 52 may become the interference wave (I). The reception station 30 cannot weaken the interference wave (I) that has reached the reception station 30 by itself. On the other hand, in order to ensure desired communication quality, it is necessary to cause the reception station 30 to transmit a signal having a C/I that meets the standards.

If the transmission output of the wireless signal emitted from the interference source 52 can be weakened or an installation location of the interference source 52 can be changed, the above-described request can be satisfied by suppressing the intensity of the interference wave (I) reaching the reception station 30. However, in a case where a business operator that manages the interference source 52 is different from a business operator that operates the transmission station 10 and the reception station 30, it is necessary to mediate between the business operators, and thus, the above-described change is a very large-scale task.

As another method of increasing the C/I, it is conceivable to increase the transmission output of the carrier wave (C) emitted from the transmission station 10. However, for an apparatus that relays a wireless signal, such as the reception station 30 in the present embodiment, the strength of a relay signal may be limited. For example, in a case where the reception station 30 is an apparatus that needs to satisfy the radio law-related examination standards of Japan, the signal reaching the reception port of the reception station 30 has to comply with a standard reception input value specified by the examination standards. Therefore, the transmission output used by the transmission station 10 is not freely increased.

Hereinafter, under such a background, an outline of processing executed by the wireless communication system of the present embodiment to cause the reception station 30 to function as a relay apparatus without requiring mediation with another business operator and while complying with the definition of the standard reception input value will be described.

As described above, at the upper part of FIG. 2, an example in which the C/I of the reception input 50-2 is “30 dB” is illustrated. In the following description, it is assumed that a standard reception input value that the reception station 30 should comply with is “35 dB”. Hence, in this case, the C/I of the reception input 50-2 is insufficient by “5 dB” with respect to the standard reception input value.

In a case where the C/I of the reception input 50-2 is insufficient with respect to the C/I that is to be secured, the control unit 42 of the reception station 30 requests the attenuator 38 to attenuate the signal intensity corresponding to the shortage of the C/I and requests the transmission station 10 to increase an output corresponding to the shortage of the C/I. That is, in the above-described example, the attenuator 38 of the reception station 30 needs to attenuate the reception input by “5 dB”, and the transmission station 10 needs to increase the transmission output by “5 dB”.

On the upper right side of FIG. 2, an attenuation input 50-3 generated by attenuation of “5 dB” on the reception input 50-2 which is performed by the attenuator 38 that has received the above-described command is illustrated. As illustrated in the drawing, the attenuation input 50-3 becomes a signal that has the intensity lower than the reception input 50-2 by “5 dB” and has a C/I of “30 dB”. This input 50-3 still does not satisfy the standard reception input value.

On the left side of the lower part of FIG. 2, a transmission output 50-4 generated by an increase in the transmission output which is performed by the transmission station 10 in response to the transmission output change request is illustrated. The intensity of the output 50-4 is increased by “5 dB” as compared with the output 50-1 before the transmission output change.

At the lower center of FIG. 2, a reception input 50-5 generated by reaching of both the transmission output 50-4 having the intensity increased by “5 dB” and the interference wave (I) from the interference source 52 to the reception station 30 is illustrated. Since the intensity of the carrier wave (C) is increased while the intensity of the interference wave (I) is not changed, a C/I of the reception input 50-5 is changed to “35 dB”. However, since the intensity including the interference wave (I) exceeds the standard reception input value, the input 50-5 does not satisfy the specifications of the radio law-related examination standards as it is.

At the lower right side of FIG. 2, an attenuation input 50-6 generated by attenuation of the reception input 50-5 by “5 dB” which is performed by the attenuator 38 is illustrated. As illustrated in the drawing, the attenuation input 50-6 becomes a signal that has the intensity lower than the reception input 50-5 by “5 dB” and has a C/I of “35 dB”. This input 50-6 satisfies the requirement of the standard reception input value. In the present embodiment, the attenuator 38 of the reception station 30 provides the attenuation input 50-6 generated as described above to the reception port. Therefore, the reception station 30 of the present embodiment can relay the wireless signal in a state where the desired communication quality can be ensured even in an environment where a carrier wave and an interference wave have to coexist.

### Flow of Processing in Embodiment 1

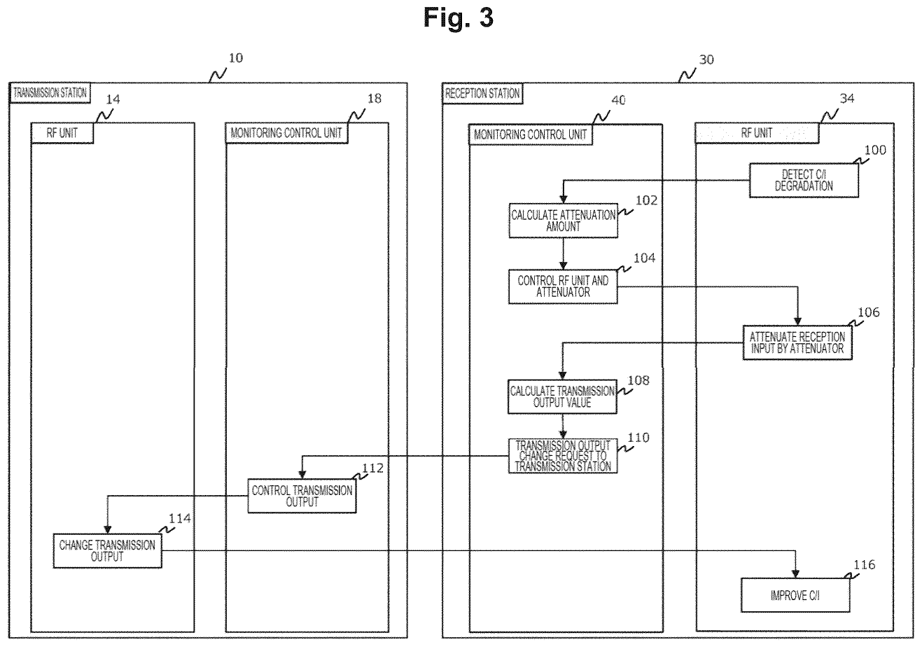

FIG. 3 is a flowchart for describing a flow of main processing executed in the wireless communication system of the present embodiment. As illustrated in FIG. 3, when the wireless signal is received, the reception station 30 detects a decrease in C/I of the reception input in the RF unit 34 (Step 100).

Next, the monitoring control unit 40 calculates an attenuation amount of C/I, that is, an insufficient amount with respect to the C/I (for example, the standard reception input value) that is to be secured (Step 102). Next, the attenuator 38 is controlled to attenuate the reception input by an amount of the intensity corresponding to the insufficient amount (Step 104). As a result, the attenuator 38 performs attenuation corresponding to the shortage of the C/I on the reception input provided from the reception unit 36 (Step 106).

The reception station 30 also calculates a current transmission output value (Step 108). Next, a transmission output change request is transmitted to the transmission station 10 to increase the transmission output by the amount of the intensity corresponding to the shortage of the C/I (Step 110).

When the transmission output change request is received, the transmission station 10 controls the transmission output in the monitoring control unit 18 to meet the received request (Step 112). As a result, in the RF unit 14, the transmission output is changed, and a signal having an increased intensity by a value corresponding to the shortage of the C/I is transmitted (Step 114).

The reception station 30 receives the carrier wave (C) having an increased intensity together with the interference wave (I) having the unchanged intensity. Since the attenuator 38 is controlled to apply the above-described attenuation to the reception input, the C/I of the reception input is improved so that a standard that is to be met is satisfied (Step 116).

As described above, according to the wireless communication system of the present embodiment, it is possible to appropriately improve the C/I even in an environment where a carrier wave and an interference wave have to coexist. Therefore, according to this system, even in an environment where an interference wave is generated, it is possible to continue to stably provide excellent communication quality without requiring a large amount of cost and labor and while complying with the regulations of the radio law and the like.

### Modification Example of Embodiment 1

Incidentally, in Embodiment 1 described above, the reception station 30 is configured to include the attenuator 38 in the RF unit 34. However, the present disclosure is not limited thereto. The configuration of the present disclosure may be realized by externally installing the attenuator 38 for an existing reception station that does not include an attenuator.

### REFERENCE SIGNS LIST

10 Transmission station
20, 42 Control unit
30 Reception station
36 Reception unit
38 Attenuator
50-1, 50-4 Transmission output
50-2, 50-5 Reception input
50-3, 50-6 Attenuation input

1. A wireless communication system comprising: a transmission station of a wireless signal, which performs a variable transmission output; and a reception station having a function of relaying the wireless signal, wherein
the reception station includes
an attenuator that attenuates a reception input captured from an antenna at a desired attenuation rate, and
the reception station is configured to execute:
detecting a C/I that is an intensity ratio between a carrier wave C that is sent from the transmission station and reaches the antenna and an interference wave I that reaches the antenna;
requesting the transmission station to increase the transmission output in a case where the C/I is smaller than a request value to be secured; and
requesting the attenuator to attenuate the reception input in a case where the C/I is smaller than the request value.

2. The wireless communication system according to claim 1, wherein
the reception station is configured to execute
calculating a shortage of the C/I of the reception input captured from the antenna with respect to the request value,
the requesting an increase in the transmission output is a demanding an increase in the transmission output corresponding to the shortage, and
the requesting attenuation of the reception input is a process of demanding attenuation of the reception input corresponding to the shortage.

3. The wireless communication system according to claim 1, wherein the request value is a standard reception input value defined by radio law-related examination standards.

4. The wireless communication system according to claim 1, wherein the attenuator is externally added to an existing reception station that does not include the attenuator.

5. A wireless communication method using a transmission station of a wireless signal, which performs a variable transmission output and a reception station having a function of relaying the wireless signal, wherein
the reception station includes an attenuator that attenuates a reception input captured from an antenna at a desired attenuation rate, and
the wireless communication method includes:
detecting a C/I that is an intensity ratio between a carrier wave C that is sent from the transmission station and reaches the antenna and an interference wave I that reaches the antenna;
requesting the transmission station to increase the transmission output in a case where the C/I is smaller than a request value to be secured; and
requesting the attenuator to attenuate the reception input in a case where the C/I is smaller than the request value.

6. The wireless communication method according to claim 5, further comprising
calculating a shortage of the C/I of the reception input captured from the antenna with respect to the request value, wherein
requesting the increase in the transmission output includes demanding an increase in the transmission output corresponding to the shortage, and
requesting the attenuation of the reception input includes demanding attenuation of the reception input corresponding to the shortage.

7. A wireless signal receiving apparatus having a function of relaying a wireless signal transmitted from a transmission station that performs a variable transmission output, the wireless signal receiving apparatus comprising:
an attenuator that attenuates a reception input captured from an antenna at a desired attenuation rate, wherein
the wireless signal receiving apparatus is configured to execute:
detecting a C/I that is an intensity ratio between a carrier wave C that is sent from the transmission station and reaches the antenna and an interference wave I that reaches the antenna;
requesting the transmission station to increase the transmission output in a case where the C/I is smaller than a request value to be secured; and
requesting the attenuator to attenuate the reception input in a case where the C/I is smaller than the request value.

8. The wireless signal receiving apparatus according to claim 7, wherein
the wireless signal receiving apparatus is configured to execute
calculating a shortage of the C/I of the reception input captured from the antenna with respect to the request value, wherein
requesting the increase in the transmission output includes demanding an increase in the transmission output corresponding to the shortage, and
requesting the attenuation of the reception input includes demanding attenuation of the reception input corresponding to the shortage.

9. The wireless communication system according to claim 2, wherein the request value is a standard reception input value defined by radio law-related examination standards.

10. The wireless communication system according to claim 2, wherein the attenuator is externally added to an existing reception station that does not include the attenuator.

11. The wireless communication system according to claim 3, wherein the attenuator is externally added to an existing reception station that does not include the attenuator.

12. The wireless communication system according to claim 9, wherein the attenuator is externally added to an existing reception station that does not include the attenuator.
